(19) United States
(12) Patent Application Publication
(10) Pub. No.: US 2010/0033689 A1
(43) Pub. Date: Feb. 11, 2010

(54) COOLING SOLUTION FOR A SOLID STATE LIGHT ILLUMINATED DISPLAY

(75) Inventors: Scott Patrick Overmann, Allen, TX (US); Steve Smith, Allen, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/189,470

(22) Filed: Aug. 11, 2008

(51) Int. Cl. G03B 21/16; F28F 7/00

(52) U.S. Cl. 353/61; 165/80.3

(57) ABSTRACT

Provided in one embodiment is a heatsink. The heatsink may include a rib having first and second opposing surfaces. The heatsink may further include a first set of fins extending from the first surface, and a second set of fins extending from the second surface. The heatsink may further include one or more mounts configured to secure one or more solid state illumination sources to the rib.

### TECHNICAL FIELD

The disclosure is directed, in general, to cooling solutions and, more specifically, to a cooling solution for a solid state light illuminated display.

### BACKGROUND

Display systems (e.g., projection display systems) tend to operate in a high temperature environment due in part to the internal illumination assembly used to provide light thereto. One particular component critically susceptible to the high temperature environment is the spatial light modulator (SLM), such as a DMD or other micro-electro mechanical system device. In the case of the SLM, illumination is focused on to its surface to be modulated and then reflected onto a display surface. It is important that the SLM be properly cooled to a specified operating temperature range for reliable, long life operation of the system.

As display systems move from traditional lamp based illumination sources to solid state based illumination sources, another particular component critically susceptible to the high temperatures is the solid state based illumination source itself. As opposed to the traditional lamp based illumination source, and in line with the SLM devices, it is important that the solid state based illumination source be properly cooled to a specified operating temperature range for reliable, long life operation thereof.

Accordingly, what is needed is a cooling solution for solid state illumination sources.

### SUMMARY

To address the above-discussed deficiencies of the prior art, provided in one embodiment is a heatsink. The heatsink may include a rib having first and second opposing surfaces. The heatsink may further include a first set of fins extending from the first surface, and a second set of fins extending from the second surface. The heatsink may further include one or more mounts configured to secure one or more solid state illumination sources to the rib.

Provided in another embodiment is a display system. The display system, among others elements, may include 1) a chassis, 2) a heatsink located within the chassis, the heatsink including, a rib having first and second opposing surfaces, the rib having three or more mounts associated therewith, a first set of fins extending from the first surface, and a second set of fins extending from the second surface, 3) three or more solid state illumination sources located within the chassis and secured to the three or more mounts associated with the rib, 4) a spatial light modulator located within the chassis and in optical communication with the three or more solid state illumination sources and having an array of addressable pixels, 5) control electronics located within the chassis for receiving image data and controlling the three or more solid state illumination sources and the spatial light modulator, and 6) projection optics located within the chassis and placed in a manner to magnify and project an image received from the spatial light modulator onto a viewing screen

### BRIEF DESCRIPTION OF THE DRAWINGS

For a more complete understanding of the disclosure, reference is now made to the following descriptions taken in conjunction with the accompanying drawings, in which:

FIG. 1 illustrates a heatsink in accordance with the disclosure;

FIG. 2 illustrates an alternative heatsink in accordance with the disclosure;

FIG. 3 illustrates yet an alternative heatsink in accordance with the disclosure; and

FIG. 4 illustrates a display system in accordance with the disclosure.

### DETAILED DESCRIPTION

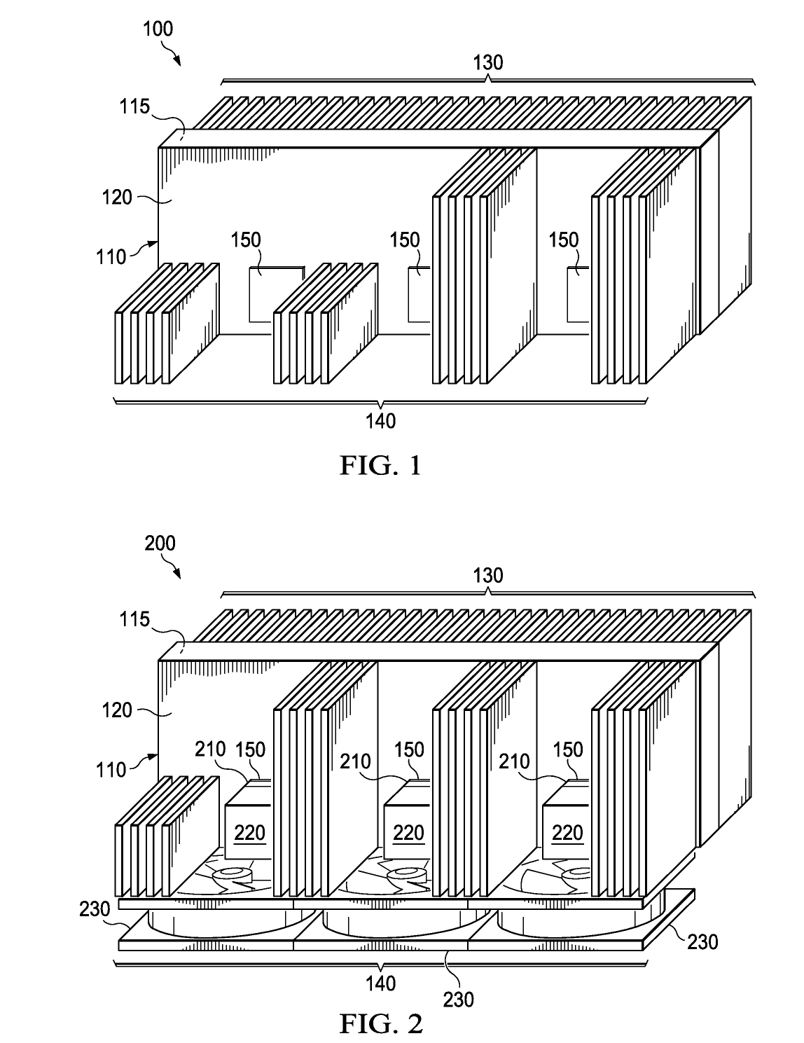

FIG. 1 illustrates a heatsink 100 manufactured in accordance with the disclosure. The heatsink 100 of FIG. 1 includes a rib 110, having first and second opposing surfaces 115, 120. The heatsink 100 of FIG. 1. additionally includes a first set of fins 130 extending from the first surface 115 and a second set of fins 140 extending from the second surface 120. In one embodiment, the rib 110 is a central rib, such that the first and second sets of fins 130, 140 extend a substantially similar distance from the first and second surfaces 115, 120, respectively. In other embodiments, not shown, the rib 110 is located in a central region of the heatsink 100, but not right in the center of the heatsink 100 such as shown in FIG. 1, so that the first and second sets of fins 130, 140 extend different distances from the first and second surfaces 115, 120, respectively.

The rib 110 and first and second sets of fins 130, 140, may comprise many different materials and remain within the purview of the disclosure. In one embodiment, each comprises aluminum or an alloy thereof. In another embodiment, each comprises copper or an alloy thereof. Other materials could also be used. In an alternative embodiment, the rib 110 and first and second sets of fins 130, 140, comprise different materials from one another. For example, the rib might comprise aluminum (e.g., for support) and the first and second sets of fins 130, 140, might comprise copper.

The rib 110, in certain embodiments, may include a heat pipe. In such an embodiment, the heat pipe might function as a heat transfer mechanism to transport large quantities of heat with a very small difference in temperature between hotter and colder interfaces. For example, inside a heat pipe, at the hot interface a fluid generally turns to vapor and the gas naturally flows and condenses on the cold interface. The liquid may then fall with the aid of gravity (or is moved by capillary action) back to the hot interface to evaporate again and repeat the cycle.

The heat pipe, or pipes when used, may entertain various different configurations with the rib 110. In one embodiment, the rib 110 itself functions as a single heat pipe. In another embodiment, the rib 110 might include a single heat pipe therein. In yet another embodiment, the rib 110 might include multiple different heat pipes therein. In all such embodiments, however, the heat pipes are configured to assist in the transfer of heat away from the one or more solid state illumination sources.

The heatsink 100 of FIG. 1 additionally includes one or more mounts 150 associated therewith. In the embodiment of FIG. 1, the mounts 150 are configured in such a way as to attach one or more solid state illumination sources thereto. The mounts 150 may comprise any securing feature designed to firmly attach the one or more solid state illumination sources to the heat sink 100, whether formed from the rib 110 or attached thereto using other mechanisms. Moreover, the securing features may be configured to either rigidly attach, or alternatively removably attach, the one or more solid state illumination sources to the heat sink 100. In those embodiments wherein the securing features allow removal of the one or more solid state illumination sources, as opposed to the one or more solid state illumination sources being rigidly attached to the heatsink 100, such solid state illumination sources may be replaced if ever need be.

The mounts 150 may additionally include alignment features, such that the one or more solid state illumination sources are precisely located at the same location within the heatsink 100. The precision allowed by such alignment features is particularly beneficial in those embodiments wherein the heatsink 100 and associated solid state illumination sources are employed with a spatial light modulator (SLM) in a display system. For example, the alignment features may be used to precisely align the one or more solid state illumination sources relative to the heatsink 100, which in turn would be precisely aligned relative to the SLM. Those skilled in the art of alignment understand the various different alignment features that could be used to align the one or more solid state illumination sources relative to the heatsink 100.

The mounts 150 illustrated in FIG. 1 are associated with an uncovered portion of the second surface 120 of the rib 110. For example, the mounts 150 are associated with portions of the second surface 120 that are exposed by the second set of fins 140. Depending on the embodiment, the mounts 150 may be surrounded on one, two, three or even four sides by the second set of fins 140. In those embodiments wherein the mounts 150 are surrounded on three or four sides by the second set of fins 140, the mounts might be nested within the second set of fins 140, such as within a cavity created by the second set of fins 140.

A heatsink having a central rib, such as the rib 110, provides many benefits over traditional heatsinks. First, the central rib provides for shortened fin lengths, which increases efficiency. Second the rib allows for heat pipes to be embedded therein, which additionally increases efficiency. Third, the central rib serves as a mechanical mounting base for the solid state illumination sources, which has many of its own benefits (e.g., alignment). Additionally, as the solid state illumination sources may be positioned within a footprint created by the first and second sets of fins, thinner display device are attainable.

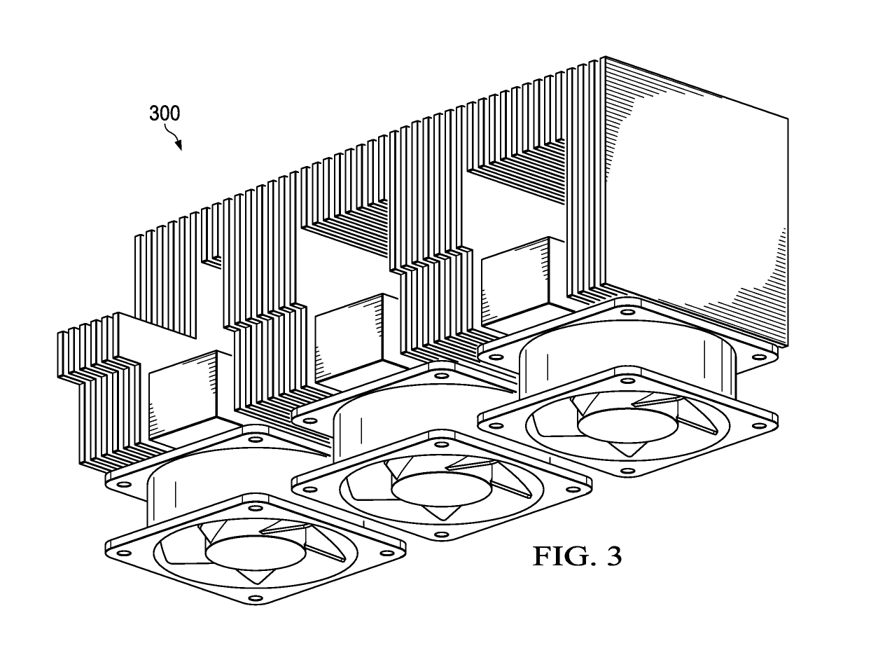

FIG. 2 illustrates an alternative heatsink 200 manufactured in accordance with the disclosure. The heatsink 200 of FIG. 2 and the heatsink 100 of FIG. 1 share many similar features. Accordingly, like reference numerals have been used in FIGS. 1 and 2 to indicate similar, maybe not exact, features.

In addition to those features already discussed, the heatsink 200 of FIG. 2 further includes one or more thermo-electric coolers 210 associated with the one or more mounts 150. The thermo-electric coolers 210, as those skilled in the art would expect, may use the Peltier effect to create a heat flux between the junction of two different types of materials. For example, the thermo-electric coolers 210, in one embodiment, are solid-state active heat pumps which transfer heat from one side of the device to the other side, against the temperature gradient (e.g., from cold to hot), with consumption of electrical energy. By simply connecting such thermo-electric coolers 210 to a DC voltage, one side thereof will cool while the other side thereof will warm. The effectiveness of the thermo-electric coolers 210 at moving the heat away from the cold side is typically dependent upon the amount of current provided and how well the heat from the hot side can be removed.

When used, the thermo-electric coolers 210 assist in the removal of heat from the one or more solid state illumination sources. For example, the thermoelectric coolers 210 may be used to control the temperature of the solid state illumination sources independent of operating ambient temperature. Additionally, the current provided to the thermo-electric coolers may be adjusted (e.g., in real time in certain embodiments) to maintain the solid state illumination source at a constant temperature, for example over a wide range of operating conditions. As those skilled in the art appreciate, maintaining the solid state illumination source at a constant temperature allows for consistent light output, allowing white point control and proper balance between colors, among other benefits.

Coupled to the rib 110, with the one or more thermo-electric coolers 210 disposed therebetween, are one or more solid state illumination sources 220. As those skilled in the art are aware, solid state illumination sources employ a solid object, such as a semiconductor, to emit their light, rather than emitting their light from a vacuum or gas tube, as is the case in traditional incandescent light bulbs and fluorescent lamps. Two readily known solid state illumination sources are a laser illumination source and a light emitting diode (LED) illumination source. Nevertheless, other solid state illumination sources exist, including organic LEDs and polymer LEDs, among possible others.

In the embodiment of FIG. 2, three solid state illumination sources 220 are being used. For example, one might provide red light, another might provide green light and the last blue light. In other embodiments, more than three solid state illumination sources, for example adding cyan and magenta in addition to the red, green and blue sources. In yet another embodiment, a single solid state illumination source might be used, for example in conjunction with a color wheel. Other embodiments may also exist.

The heatsink 200 of FIG. 2 further includes one or more fans 230 coupled thereto (e.g., whether directly coupled thereto or through the use of one or more intervening features). In accordance with the disclosure, the one or more fans 230 may include any device configured to move air. For example, in one embodiment the one or more fans 230 comprise one or more axial fans. In another embodiment, however, the one or more fans 230 may comprise one or more cross flow fans or centrifugal fans (each of which are configured to move air), as opposed to axial fans.

In the example embodiment of FIG. 2, the heatsink 200 includes three fans 230. In this example embodiment, one fan 230 is associated with each of the different solid state illumination sources 220, as shown in FIG. 2. In another embodiment, not shown, a single fan 230 could be used to cool all of the different solid state illumination sources 220. In yet another embodiment, a different number of fans 230 than number of illumination sources 220 could be used to assist in removal of heat from the heatsink 200. The multiple fans, when used, may allow for lower fan speeds, and thus lower acoustic noise levels.

FIG. 3 illustrates an alternative heatsink 300 manufactured in accordance with the disclosure. The heatsink 300 illustrates yet other configurations for the rib, sets of fins, one or more solid state illumination sources, fans, etc.

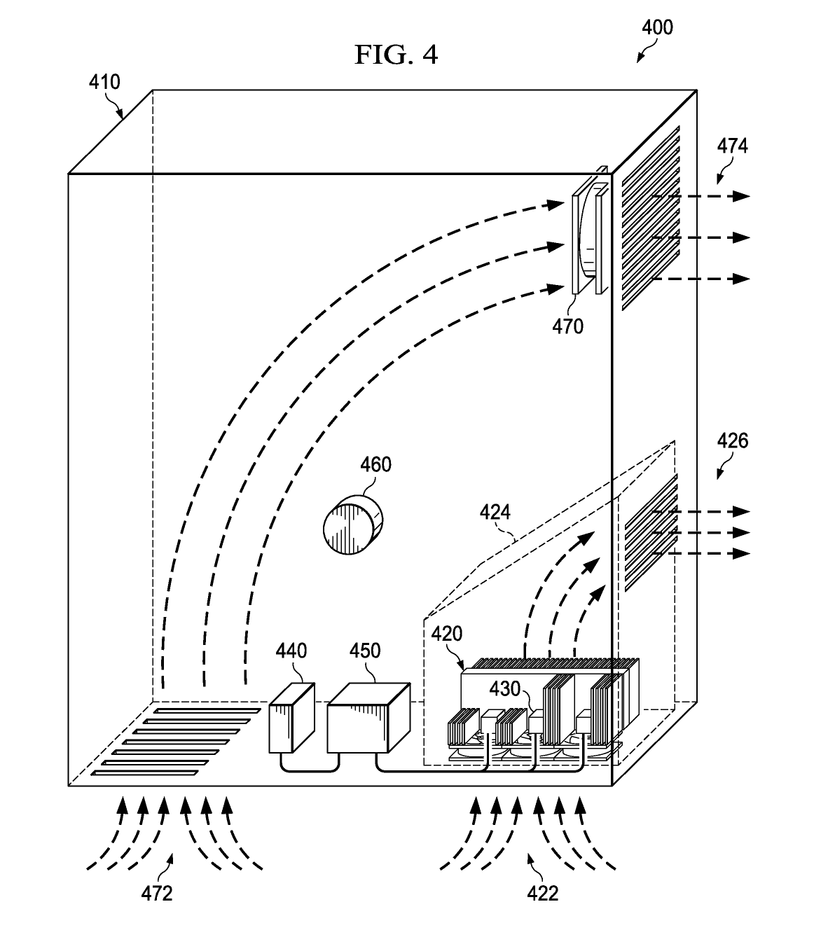

FIG. 4 illustrates a display system 400 manufactured in accordance with the disclosure. The display system 400 initially includes a chassis 410. The chassis 410 may be any enclosure used in a display system. For example, the chassis 410 might be a chassis as is often used in a rear projection television, or alternatively a chassis as is often used in a front projection display (commonly called a projector), among others.

The display system 400, in the embodiment of FIG. 4, includes a heatsink 420 located within the chassis 410. The heatsink 420, in accordance with the disclosure, may include a rib having first and second opposing surfaces. The heatsink 420, in this embodiment, may further include three or more mounts associated with the rib. Additionally, the heatsink 420 may include first and second sets of fins extending from the first and second surfaces, respectively. In one example embodiment, the heatsink 420 is similar to one of the heatsinks 100, 200, 300 illustrated and discussed with respect to FIGS. 1, 2 and 3, respectively.

The heatsink 420, in one embodiment, is positioned proximate an exterior surface of the chassis 410. For example, the heatsink 420 may be placed near the exterior surface so as to allow the one or more fans associated therewith to pull intake air 422 directly from an environment surrounding the chassis 410 and move it over the heatsink 420 without the intake air 422 being preheated by other components within the chassis 410.

The heatsink 420 may further have an exhaust plenum 424 associated therewith. The exhaust plenum 424, in this embodiment, may be configured to remove heated intake air 426 having already passed over the heatsink 420 from the chassis 410. This heated intake air 426 may then exit the chassis 410 without heating other components located within the chassis 410. Additionally, the exhaust plenum 424 may direct the heated intake air 426 away from the chassis 410 such that the heated intake air 426 is not easily pulled back into the chassis 410 by the one or more fans as the intake air 422 (or intake air 472 for that matter). Those skilled in the art understand the various different exhaust plenums that might be used to accommodate the desire to remove the heated intake air 426 from the chassis 410.

The display system 400 of FIG. 4 further includes three or more solid state illumination sources 430. The three or more solid state illumination sources 430, in this disclosed embodiment, are located within the chassis 410 and secured to the one or more mounts associated with the ribs of the heatsink 420. The three or more solid state illumination sources 430 may, in certain embodiments, be similar to the solid state illumination sources 220 discussed with regard to FIG. 2.

Positioned within the chassis 410 of FIG. 4 is a spatial light modulator (SLM) 440. The SLM 440, in this embodiment, is further located in optical communication with the three or more solid state illumination sources 430. In one embodiment, the SLM 440 is a digital micromirror device (DMD) employing an array of addressable pixels. Nevertheless, those skilled in the art understand the various different SLMs that might be used, for example depending on the specific application.

Further positioned within the chassis 410 of FIG. 4 are control electronics 450. The control electronics 450, in the embodiment shown, are configured to receive image data and control the three or more solid state illumination sources and the SLM 440 based thereon. Accordingly, the control electronics 450 of FIG. 4 are in signal communication with such features.

Additionally positioned within the chassis 410 are projection optics 460. The projection optics 460, in this embodiment, are placed in a manner to magnify and project an image received from the SLM 440 onto a viewing screen. Those skilled in the art understand the various different projection optics 460, and the positioning thereof, that might be used to accommodate this desire.

In those embodiments wherein the chassis 410 forms at least a portion of a rear projection television, as discussed above, the viewing screen may form a portion of the display system 400 (e.g., integrally formed with the chassis 410 in one instance). However, in those embodiments wherein the chassis 410 forms at least a portion of a front projection display, the viewing screen may be an external screen placed upon a wall, hanging from the ceiling or held up by a stand. Other configurations for the viewing screen may also exist.

The display system 400 of FIG. 4 may additionally include a chassis fan 470. The chassis fan 470, in this embodiment, exists in addition to the one or more fans associated with the heatsink 420. However, as compared to the one or more fans associated with the heatsink 420, the chassis fan 470 is configured to draw additional intake air 472 into the chassis 410 and over the other components within the chassis 410. Accordingly, in the embodiment of FIG. 4, the intake air and the intake air 472 remain separate from one another while within the chassis 410. Those skilled in the art understand the benefits a display system, such as the display system 400, may experience as a result of this configuration. Accordingly, the intake air 472 would exit the chassis 410 as heated intake air 474.

Those skilled in the art to which the disclosure relates will appreciate that other and further additions, deletions, substitutions and modifications may be made to the described embodiments without departing from the scope thereof.

What is claimed is:

1. A heatsink, comprising:
a rib having first and second opposing surfaces;
a first set of fins extending from the first surface; and
a second set of fins extending from the second surface, wherein one or more mounts are configured to secure one or more solid state illumination sources to the rib.

2. The heatsink as recited in claim 1, wherein the one or more mounts are associated with an uncovered portion of the second surface.

3. The heatsink as recited in claim 2, wherein the second set of fins expose the uncovered portion of the second surface.

4. The heatsink as recited in claim 2, wherein the one or more mounts are nested within the second set of fins.

5. The heatsink as recited in claim 1, wherein the rib is a central rib, and further wherein the first and second sets of fins extend a substantially similar distance from the first and second surfaces.

6. The heatsink as recited in claim 1, wherein the rib includes one or more heat pipes embedded therein.

7. The heatsink as recited in claim 1, wherein the rib is configured as a single heat pipe.

8. The heatsink as recited in claim 1 further including one or more thermo-electric coolers associated with the one or more mounts.

9. The heatsink as recited in claim 1 further including one or more fans coupled to and configured to cool the first and second sets of fins.

10. The heatsink as recited in claim 9, wherein single ones of the one or more fans are associated with single ones of the one or more mounts.

11. The heatsink as recited in claim 1, wherein the one or more mounts are configured to secure one or more laser illumination sources thereto.

12. The heatsink as recited in claim 1, wherein the one or more mounts are configured to secure one or more light emitting diode (LED) illumination sources thereto.

13. A display system, comprising:
a chassis;
a heatsink located within the chassis, the heatsink including:
a rib having first and second opposing surfaces, the rib having three or more mounts associated therewith;
a first set of fins extending from the first surface; and
a second set of fins extending from the second surface;
three or more solid state illumination sources located within the chassis and secured to the three or more mounts associated with the rib;
a spatial light modulator located within the chassis and in optical communication with the three or more solid state illumination sources and having an array of addressable pixels;
control electronics located within the chassis for receiving image data and controlling the three or more solid state illumination sources and the spatial light modulator; and
projection optics located within the chassis and placed in a manner to magnify and project an image received from the spatial light modulator onto a viewing screen.

14. The display system as recited in claim 13, wherein the heatsink further includes one or more fans coupled thereto, and further wherein the one or more fans are positioned proximate an exterior surface of the chassis so as to pull intake air directly from an environment surrounding the chassis and move it over the heatsink without the intake air being preheated by other components within the chassis.

15. The display system as recited in claim 14 further including an exhaust plenum associated with the heatsink and configured to remove heated intake air already having been passed over the heatsink from the chassis, without the heated intake air heating other components located with the chassis.

16. The display system as recited in claim 15, wherein the exhaust plenum is positioned such that the heated intake air exiting the chassis is not easily pulled back into the chassis by the one or more fans as the intake air.

17. The display system as recited in claim 14, wherein single ones of the one or more fans are associated with single ones of three or more solid state illumination sources.

18. The display system as recited in claim 14 further including a chassis fan configured to draw additional intake air over the other components within the chassis.

19. The display system as recited in claim 13, wherein the rib includes one or more heat pipes embedded therein.

20. The display system as recited in claim 13 further including one or more thermo-electric coolers positioned between the three or more mounts and the three or more solid state illumination sources.
